(19) United States
(12) Patent Application Publication
(10) Pub. No.: US 2009/0006492 A1
(43) Pub. Date: Jan. 1, 2009

(54) Displayname and Resource Identifier Synchronization

(76) Inventors: Andreas J. Heix, Heidelberg (DE); Hans-Juergen Richstein, Rauenberg (DE); Frank H. Albrecht, Walldorf (DE)

Correspondence Address: MINTZ, LEVIN, COHN, FERRIS, GLOVSKY & POPEO, P.C.;ATTN: PATENT INTAKE CUSTOMER NO. 64280, ONE FINANCIAL CENTER, BOSTON, MA, 02111, US

(21) Appl. No.: 12/209,892

(22) Filed: Sep. 12, 2008

Related U.S. Application Data
(63) Continuation of application No. 10/817,106, filed on Apr. 2, 2004.

(51) Int. Cl. G06F 17/30

(52) U.S. Cl. 707/201; 707/E17.005

(57) ABSTRACT

Methods and apparatus, including computer systems and program products synchronizing a displayname and a resource identifier. In one technique, a machine-implemented method includes receiving input corresponding to a displayname of a data resource; preparing a resource identifier of the data resource within a repository based on the input and naming conventions associated with the repository; and preparing the displayname of the data resource based on the input. The resource identifier may be prepared such that the resource identifier resembles the displayname. Naming conventions may include a naming convention that requires a content-type extension to be retained by a resource identifier. The displayname may be presented to a user interface such that only the displayname is displayed and a corresponding resource identifier is excluded from being displayed.

### CROSS REFERENCE TO RELATED APPLICATIONS

The present application claims priority under 35 U.S.C. §120 to U.S. application Ser. No. 10/817,106, filed Apr. 2, 2004, entitled DISPLAYNAME AND RESOURCE IDENTIFIER SYNCHRONIZATION, the disclosure of which is incorporated herein by reference.

### BACKGROUND

The following description relates to synchronization of a displayname and a resource identifier.

Computer systems typically include or have access to one or more data repositories, which are storage systems or locations where resources may be stored. Resources may include files; file folders; links to those files and/or folders; and collections that represent resources. Data repositories may be organized differently and may have different rules that pertain to the organization of resources. For example, filenames in one type of data repository may be limited to a length of eleven characters, including a three-character extension, whereas filenames in another type of data repository may be limited to a length of 255 characters, any number of which may be an extension.

Applications and/or users of a computer system typically access data in a data repository through a repository framework. Each data repository may have its own repository framework, or a repository framework may be developed to access multiple data repositories, where each data repository may be a different type. An example of a repository framework for multiple data repositories may be a repository framework that has access to a database stored on a Microsoft Windows-based computer system and access to word-processing documents stored on a UNIX-based computer system. In that example, the repository framework may abide by rules that pertain to each type of data repository. For example, if the repository framework modifies the name of a file stored on the UNIX-based computer system, the repository framework may abide by naming conventions applicable to files in the implementation of UNIX corresponding to that computer system.

When a user views a resource through a repository framework, the user may see a resource identifier, which is an identifier of the resource within a data repository in which the resource resides. Within the data repository, the resource may further be located in a resource region, which defines the scope in which resources are identifiable such that they can be differentiated from other resources. Examples of resource identifiers include filenames for files and folder names for folders. An example of a resource region might be a file folder or a directory. In some data repositories, a resource identifier may be the only identification usable for identifying a resource. In other data repositories, a resource may also be identified by a displayname, which is an additional identifier of a resource (i.e. separate from a resource identifier) to which less naming conventions apply as compared to a resource identifier. For example, one type of data repository may have a naming convention that excludes the character ‘?’ from being part of a resource identifier although that character might be part of a displayname. A displayname is associated with a resource and may be, for example, a property of the resource or associated with the resource via a repository framework. In data repositories where a repository is identified by both a displayname and a resource identifier, both the resource identifier and the displayname may be viewed in the same user interface.

### SUMMARY

Described herein are systems and techniques, including computer program products, that implement displayname and resource identifier synchronization.

In one general aspect, a machine-implemented method includes receiving input corresponding to a displayname of a data resource; preparing a resource identifier of the data resource within a repository based on the input and naming conventions associated with the repository; and preparing the displayname of the data resource based on the input.

Implementations may include one or more of the following features. Preparing the resource identifier may include preparing the resource identifier such that the resource identifier resembles the displayname. Preparing the displayname may include modifying an existing displayname. Preparing the resource identifier may include generating the data resource and the resource identifier in the repository. Preparing the displayname may include setting a displayname property of the data resource if the repository supports display name properties. A displayname property may be a custom property of the data resource. The data resource may include a link. In that case, the method may further include determining if a target resource of the link has a displayname; and, if the target resource has a displayname, presenting the displayname of the target resource as a proposed displayname, otherwise presenting the resource identifier of the target resource as a proposed displayname. Preparing the resource identifier may include renaming the resource identifier based on the input. Preparing the resource identifier may involve including at least a portion of the displayname in the resource identifier. The method may further include presenting the displayname to a user interface. Presenting the displayname may include presenting the displayname to the user interface and excluding the resource identifier from being presented to the user interface.

The naming conventions associated with the repository may include a naming convention that defines at least one set of characters to be excluded from the resource identifier. Preparing the resource identifier based on that naming convention includes, if a proposed resource identifier has a set of character to be excluded from the resource identifier, mapping the set of characters to one or more characters that can be included in the resource identifier. The naming conventions associated with the repository may include a naming convention excluding duplicate resource identifiers in a resource region. In that case, preparing the resource identifier based on that naming convention includes modifying a proposed resource identifier, if another data resource, in a same resource region as the data resource, has a second resource identifier that is identical to the proposed resource identifier. The naming conventions may include a naming convention that retains content-type extensions in the resource identifier. In that case, preparing the resource identifier based on that naming convention involves including a content-type extension in the resource identifier regardless of the input.

In another aspect, a system includes repositories configured to store data resources, and an adapter. In that aspect, the adapter is operative to perform operations that include receiving input corresponding to a displayname of a data resource; preparing a resource identifier of the data resource within at least one of the repositories based on the input and naming conventions associated with the at least one of the repositories; and preparing the displayname of the data resource based on the input.

Implementations may include one or more of the following features. The system may further include a second adapter. In that case, the repositories comprise at least two types of repositories, each adapter corresponds to a type of repository, and each adapter is configured to prepare a resource identifier based on naming conventions associated with the type of repository corresponding to that adapter. The operation of preparing the resource identifier may include preparing the resource identifier such that the resource identifier resembles the displayname. An adapter may be further operative to perform operations, such as presenting the displayname to a user interface such that the resource identifier is excluded from being presented to the user interface.

The naming conventions associated with the repositories may include a first naming convention that defines at least one set of characters to be excluded from the resource identifier, a second naming convention excluding duplicate resource identifiers in a resource region, and a third naming convention that retains content-type extensions in the resource identifier. In that case, the operation of preparing the resource identifier based on the naming conventions includes, if a proposed resource identifier has a set of character to be excluded from the resource identifier, mapping the set of characters to one or more characters that can be included in the resource identifier; modifying the proposed resource identifier if another data resource, in a same resource region as the data resource, has a second resource identifier that is identical to the proposed resource identifier; and including a content-type extension in the resource identifier of the data resource regardless of the input.

In another aspect, an article including a machine-readable medium storing instructions is operable to cause one or more machines to perform operations including receive input corresponding to a displayname of a data resource; prepare a resource identifier of the data resource within a repository based on the input and naming conventions associated with the repository; and prepare the displayname of the data resource based on the input.

Implementations may include one or more of the following features. The operation of preparing the resource identifier may include preparing the resource identifier such that the resource identifier resembles the displayname. The article may further include instructions operative to cause the one or more machines to perform operations, such as presenting the displayname to a user interface such that the resource identifier is excluded from being presented to the user interface. The naming conventions associated with the repository may include a first naming convention that defines at least one set of characters to be excluded from the resource identifier; a second naming convention excluding duplicate resource identifiers in a resource region; and a third naming convention that retains content-type extensions in the resource identifier. In that case, the operation of preparing the resource identifier based on the naming conventions includes mapping a set of characters to one or more characters that can be included in the resource identifier, if a proposed resource identifier has a set of character to be excluded from the resource identifier; modifying the proposed resource identifier if another data resource, in a same resource region as the data resource, has a second resource identifier that is identical to the proposed resource identifier; and including a content-type extension in the resource identifier of the data resource regardless of the input.

The synchronization of a displayname and a resource identifier described here may provide one or more of the following advantages. Resources available via a repository framework may have both a resource identifier and a displayname. Few naming restrictions may apply to the displayname such that a user may freely chose the displayname regardless of, for example, a file-type extension of a file (i.e. a content-type extension). The resource identifier might be visually excluded from a user such that a user might not be confused by having several identifiers associated with a single resource. Additionally, a resource identifier may resemble a displayname such that if a user is only capable of viewing the resource identifier in certain software environments, the resource may be easily identified due to the similarity of the resource identifier and the displayname. Beneficially, multiple displaynames may be identical within the same context in which resources are identified (e.g. a resource region). For example, multiple word processing documents may have the same displayname within a file folder. If the repository framework supports multiple types of data repositories, the repository framework may be customized to handle naming restrictions specific to each type of data repository. For example, some data repositories may restrict certain characters from being part of a resource identifier (i.e. certain characters are invalid and should not be included). In that example, the repository framework may ensure that depending on the type of data repository, certain characters are excluded.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIG. 1 is a block diagram illustrating a repository framework system.

FIG. 2 is a flowchart illustrating generation of resources.

FIG. 3 is a flowchart illustrating renaming of resources.

FIG. 4 is a flowchart illustrating generation of links.

### DETAILED DESCRIPTION

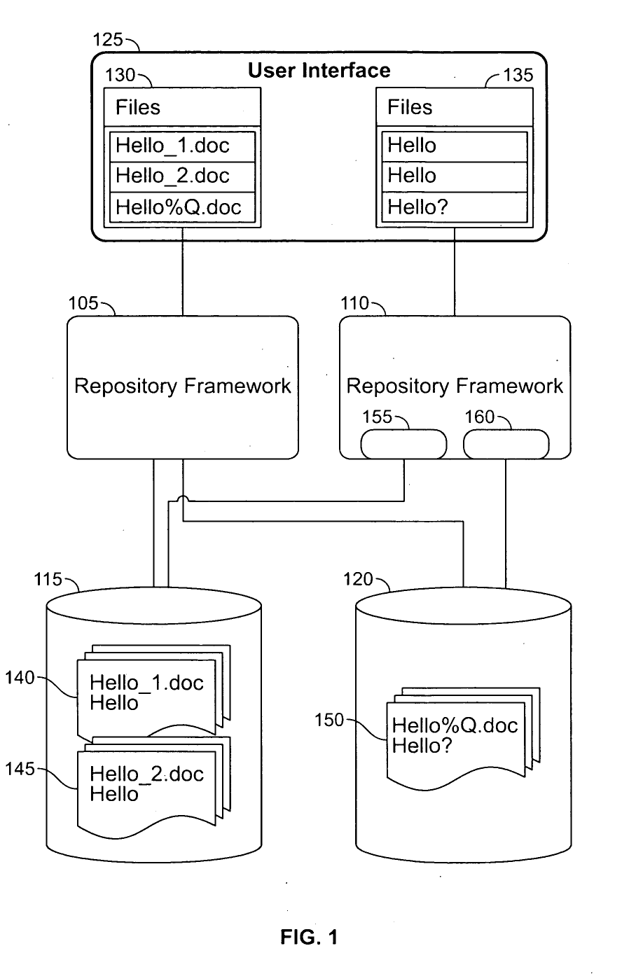

FIG. 1 is a block diagram illustrating a repository framework system. FIG. 1 will be used to illustrate mechanisms that implement techniques for synchronizing a displayname and resource identifier. The system of FIG. 1 includes repository frameworks 105 and 110; data repositories 115 and 120; and, a user interface 125. The user interface 125 includes two windows 130 and 135, each of which provides a view of files that exist in the data repositories 115 and 120. The windows 130 and 135 are provided access to the files via the repository frameworks 105 and 110, respectively.

Some of the resources in the data repositories 115 and 120 are files 140, 145, and 150. Each of the files 140, 145, and 150 has a corresponding resource identifier. A resource identifier identifies a resource within the resource region in which the resource exists. For example, the files 140 and 145 have resource identifiers “Hello_{—}1.doc” and “Hello_{—}2.doc”, respectively. Those resource identifiers identify the files within the folder in which they exist. The files 140 and 145 have “Hello” as their displayname. Each displayname is a property of each file, and need not be used to identify the files 140 and 145. For example, the resource identifier, instead of the displayname, may be used to identify a file. Resources may be representative of real world business activity. For example, the files 140 and 145 may include business data, such as financial reports, and file folders (not shown) can be used to organize those financial reports in a corresponding manner of business organization, such as organizing the financial reports by fiscal year.

Each of the windows 130 and 135 present different identifiers for the files in the data repository, which is due to differences between the repository frameworks 105 and 110. The repository framework 105 presents the resource identifiers “Hello_{—}1.doc”, “Hello_{—}2.doc”, and “Hello%Q.doc” of the files 140, 145 and 150, respectively, to the window 130. By contrast, the repository framework 110 presents the displaynames “Hello”, “Hello”, and “Hello?” of the same files, respectively, to the window 135. In order to present and modify the displaynames and resource identifiers, the repository framework 110 includes adapters 155 and 160, which correspond to the data repositories 115 and 120. The windows 130 and 135 may be used to access the files 140 and 145. For example, if the files 140 and 145 are financial reports that are stored as word processing documents, each of the windows 130 and 135 may be used to start a word processing application that allows a user to view and/or edit the financial reports.

Different adapters correspond to each of the data repositories 115 and 120 because different naming conventions apply to each of the data repositories 115 and 120. If the same naming conventions apply to each of the data repositories 115 and 120, the same adapter may be used for both of the data repositories 115 and 120. Naming conventions that apply to data repositories may include, for example, a convention limiting the maximum length of a resource identifier.

Fewer and/or different naming conventions apply to displaynames as compared to resource identifiers; thus, the repository framework 110 may beneficially provide more freedom to a user who may wish to modify an identifier of a resource if they are provided with a displayname. For example, the data repository 115 has naming conventions that restrict certain characters, such as the character ‘?’, from being part of a resource identifier; however, the data repository 115 does not restrict these characters from being part of a displayname. Thus, the file 150 excludes the question mark from its resource identifier; however, the corresponding displayname for the file 150 includes the question mark. In addition, the data repositories 115 and 120 have naming conventions that require resource identifiers of files to retain a content-type extension. This convention ensures that software, such as an operating system or application program, can determine the content-type of a resource. By contrast, displaynames need not include a content-type extension. Thus, for example, the resource identifier of the file 145 has a content-type extension “.doc” whereas the corresponding displayname does not include a content-type extension. Another naming convention typically requires that resource identifiers are unique within a certain resource region. For example, a data repository typically has a convention that requires files to have unique resource identifiers within each file folder. By contrast, the displaynames need not have unique identifiers. For example, if the files 140 and 145 were in the same file folder, their displaynames can both be “Hello”; however, the resource identifiers must be unique. Thus, the resource identifiers of the files 140 and 145 might be “Hello_{—}1.doc” and “Hello_{—}2.doc”, respectively, to ensure uniqueness of the resource identifiers.

The adapters 155 and 160 ensure that a resource identifier resembles a corresponding displayname, if possible, and ensure that the resource identifier follows applicable naming conventions. Ensuring that the resource identifier follows naming conventions may include, but is not limited to, ensuring that part of the displayname is included in the corresponding resource identifier; mapping characters from the displayname to characters in the corresponding resource identifier; modifying resource identifiers when more than one resource identifier has the same displayname in a certain resource region; and ensuring that content-type extensions are not disrupted if the resource is a file.

As an example of including a portion of a displayname in a resource identifier, the displayname for the file 150 includes “Hello”, which is also part of the corresponding resource identifier “Hello%Q.doc”. As an example of mapping characters, the displayname of the file 150 includes the character ‘?’ which is mapped to the series of characters “%Q” in the corresponding resource identifier. Characters of a displayname may be mapped to characters in a resource identifier because the data repository 115 does not allow certain characters, such as the question mark, to be part of a resource identifier. The characters that should not be in a resource identifier may be called “invalid characters” and include other characters such as ‘/’, and ‘\’.

The files 140 and 145, which are in the same file folder (i.e. resource region), provide an example of resources associated with a duplicate displayname. Duplicates can occur when there is an “identifier clash.” An identifier clash may occur for any number of reasons, including generating, renaming, moving, or copying a resource into a resource region where another resource with the same resource identifier already resides. In order to resolve an identifier clash, the resource identifiers are modified such that they vary, although the displaynames are permitted to remain the same. Thus, for example, although the files 140 and 145 may have the same displayname (i.e. “Hello”) within the same resource region (i.e. file folder), the data repository 115 does not allow duplicate resource identifiers. In order to resolve this clash, the resource identifiers corresponding to the displaynames for the files 140 and 145 were modified to the unique resource identifiers “Hello_{—}1.doc” and “Hello_{—}2.doc” (i.e. an underscore and a number are suffixed to the displayname). As an example of ensuring that content-type extensions are not disrupted, the file 140 has the resource identifier “Hello_{—}1.doc” which includes the extension “.doc”. The extension is used by the data repository 115 and is required for the operating system that manages that data repository so that the operating system can determine the content-type of the file 140. Were the extension to be changed, the content-type might not be recognized. Thus, if a user changes the displayname such that a content-type extension is disrupted (e.g. deleted) the adapter 155 ensures that the resource identifier corresponding to the file 140 includes the extension “.doc” regardless of these changes to the displayname.

Any of a number of modifications to a resource may cause the adapter to synchronize the resource identifier with the displayname. The modifications may include, but are not limited to, generating a resource, copying a resource to a different resource region, moving a resource to a different resource region, updating a resource, and renaming the displayname of a resource. Also, depending on the type of resource and the type of modification, the synchronization behavior may vary. For example, if a displayname of a file is renamed, the underlying resource identifier may be synchronized, whereas if a displayname of a link is renamed, the underlying resource identifier of the link might not be changed. Modifying and/or generating a resource identifier and/or a displayname can be regarded as preparing the resource identifier and/or the displayname, respectively.

The repository framework 105 allows users to identify files by a resource identifier rather than a displayname. For example, the file 150, which has a displayname “Hello?” is identified in the window 130 by the resource identifier “Hello%Q.doc.” The use of two identifiers (i.e. the resource identifiers in the window 130 and the displaynames in the window 135) for a single resource might not be confusing because the repository framework 110 synchronizes resource identifiers to reflect their corresponding displaynames. Continuing with the example, a user may be able to recognize that the file 150 is associated with “Hello?” and “Hello%Q.doc” because the characters “Hello” exist in both the resource identifier and the displayname. Further, the user may equate the two identifiers by deducing that % Q is a substitute for the question mark because Q is the first letter in “question mark.”

In alternative implementations, the repository framework 110 may integrate the functionality of the adapters 155 and 160. For example, a single adapter may include the functionality of multiple adapters. Also, in alternative implementations, additional, fewer, and/or different naming conventions may apply to a resource identifier. The naming conventions can depend, for example, on the type of resource and/or the type of data repository. For example, one type of data repository might not have a convention that requires resource identifiers to retain a content-type extension. Also, although certain techniques are described for each of the various conventions discussed, alternative techniques may be used. For example, different techniques may be used to deal with duplicate displaynames in the same resource region.

Although all of the files shown in FIG. 1 have displaynames, in alternative implementations each file need not have a displayname. Also, some data repositories might not support displaynames. In the case that files are not allowed to have a displayname, the corresponding resource identifier may be used instead of a displayname. In the case where a data repository does not support displaynames (e.g. a displayname property is not supported for a resource), the repository framework 110 might support the displaynames. As an example, the repository framework 110 may support displaynames by keeping an index of displaynames and corresponding resource identifiers. In that example, the repository framework 110 may provide displaynames to a user interface by using the index to determine a corresponding displayname for each resource.

In alternative implementations, resources other than, or in addition to, files may be managed by the repository frameworks 105 and 110 and presented to the user interface 125. For example, file folders or links may be managed by the repository frameworks 105 and 110. The other resources may also have a displayname corresponding to a resource identifier. The repository framework may handle resources differently depending on the type of resource involved. For example, a resource identifier corresponding to a file may always be synchronized to reflect changes to a displayname, whereas a resource identifier corresponding to a link might only be synchronized with a displayname when the link is generated. Also, although FIG. 1 describes synchronizing the resource identifier to match a displayname, the similar techniques may be applied to synchronize a displayname to represent changes to a resource identifier and/or synchronizing the resource identifier to match input which is used to modify a displayname.

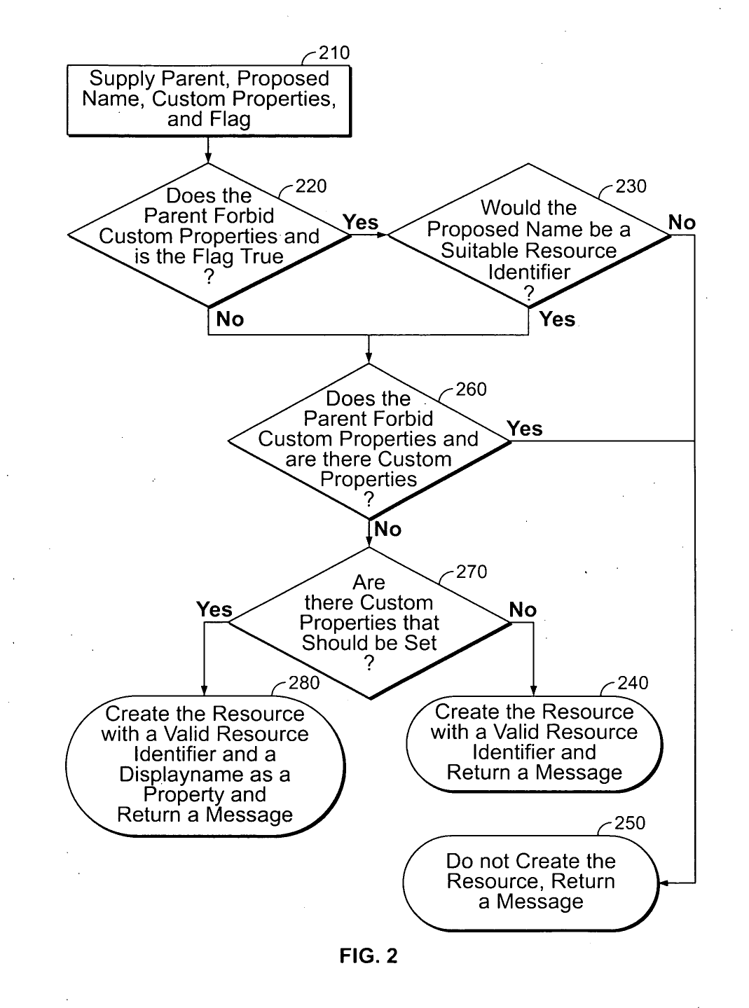

FIG. 2 is a flowchart of a technique for generating resources. The technique described in relation to FIG. 2 may apply to all types of resources, which may include, but are not limited to, files, file folders, links, and collections. A link relates to another resource (i.e. a target resource) and may be used by an application to provide access to the target resource through the link. For example, a link may have a target resource that is a word-processing document. In a graphical user interface, if a user clicks on such a link, the target document may be displayed in a word-processing application. A collection represents a collection of objects in a repository which may be, for example, the contents of a directory (i.e. file folder) in a file system. For example, a collection may represent a set of word-processing documents, each of which is a resource.

In relation to FIG. 2, a parent is a file folder where a resource is expected to be generated and a flag is a value that represents whether a proposed name should be a displayname of the resource that is expected to be generated. A parent, proposed name, custom properties, and a flag value are supplied to a repository framework, at 210. The proposed name need not be the displayname of the resource that may be generated. For example, if a repository where the resource is to be generated does not support displaynames, the proposed name may be a proposed resource identifier. The repository framework may be able to determine if a proposed name should be a displayname by determining if the flag value is true. Custom properties are properties in addition to those normally supported for a resource identifier. For example, files in a data repository may have default properties such as creation date, last modified date, and file size, which may be supported for all files. However, users of a data repository may desire that additional, custom properties are associated with a resource. In that case, depending on the implementation of a data repository and/or a repository framework, the resource may be permitted to have additional, custom properties. An example custom property may be a property “author” for the author of a word-processing document. The support for custom properties may depend on the implementations of a data repository and/or a repository framework. In alternative implementations, instead of a displayname being a custom property, a displayname may be a default property and the processes of FIG. 2 may differ to reflect that difference.

The repository framework determines if the parent forbids custom properties and if the flag value is true, at 220. In other words, the repository framework determines if displaynames are not supported and whether the proposed name is to be a displayname.

If displaynames are not supported and the proposed name should be a displayname, a determination is made as to whether the proposed name would be a suitable resource identifier at 230. The proposed name is a suitable resource identifier if the proposed name complies with naming conventions that apply to a resource identifier. The determination at 230 may be made because even if a parent forbids custom properties, such as a displayname, the repository framework may set a resource identifier as the proposed name and later display the resource identifier instead of the displayname. As an example, a proposed name of a file may be “Hello.doc” and the repository framework may determine that the proposed name should be a displayname. In that example, if all of the naming conventions that would apply to a resource identifier are observed by the proposed name, the resource identifier is set as the proposed name and a message is sent indicating that the resource identifier was renamed, at 240. After the resource is generated, a repository framework might use the resource identifier, instead of a displayname, to identify the file.

If the repository framework determines, at 230, that the proposed name would not be a suitable resource identifier, a message is returned to a user that the resource could not be generated with the proposed name and the resource is not generated, at 250; otherwise, the technique continues at 260. The technique may also continue at 260, from 220, if the parent did not forbid custom properties (i.e. the resource can have custom properties) or if the flag value was not true (i.e. the proposed name was not desired to be a displayname).

The repository framework determines whether the parent forbids custom properties and whether there are custom properties that should be set for the resource, at 260. If the repository framework determines that the parent forbids custom properties and custom properties should be set, then the resource is not generated and a message is returned to a user, at 250. The message may indicate that the resource could not be generated because the parent folder does not support custom properties. Otherwise, if there are no custom properties or if the parent does not forbid custom properties, the technique continues at 270.

The repository framework determines if there are custom properties that should be set for the resource at 270. This determination may involve determining if the proposed name should be set as a displayname or a resource identifier. If there are custom properties, the resource is generated and the custom properties are associated with the resource at 280, otherwise the resource is generated and no custom properties are associated with the resource at 240. In either case, a message is returned that the resource was generated.

In alternative implementations, generating resources need not be limited to the technique described and additional and/or different processes may be used instead. For example, a flag value might not be used and the proposed name may always be presumed to be a proposed displayname. Also, different implementations of the technique need not yield the same results. For example, 230 need not be included in an alternative implementation of the technique; thus, if a parent does forbid custom properties and a proposed name should be a displayname, a resource need not be generated.

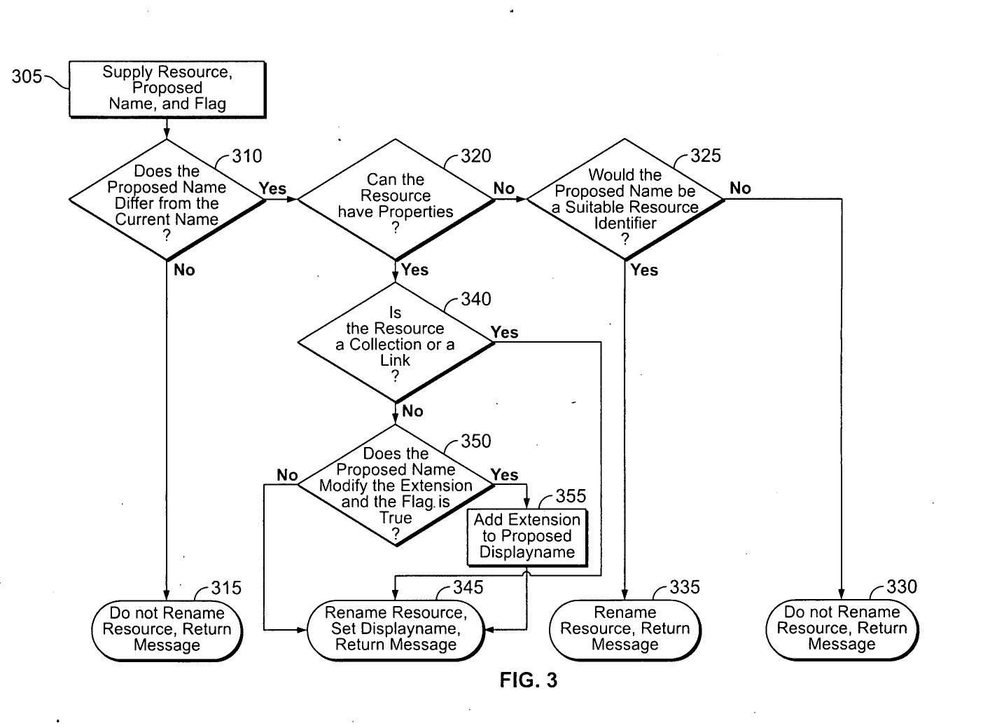

FIG. 3 is a flowchart illustrating renaming of resources. In relation to FIG. 3, parent is a file folder where a resource is expected to be generated and flag is a value that represents whether a content-type extension of a file (if the extension exists and the resource is a file) should be preserved. Note that flag in relation to FIG. 2 is different from flag in relation to FIG. 3.

A resource, a proposed name and a flag value are supplied to a repository framework at 305. The repository framework determines if the proposed name differs from the current name at 310. The current name is the displayname or, if a resource does not have a displayname, the current name is the resource identifier of the resource. If the proposed name does not differ, the name need not change, thus, a message is returned to a user that the name was not modified at 315.

If the proposed name does differ, the repository framework determines, at 320, whether a resource can have custom properties (i.e. properties in addition to those default properties which may be associated with a resource). If the resource cannot have custom properties, the resource is not allowed to have a displayname property. However, the repository framework determines at 325 whether the proposed name would be a suitable resource identifier at 325. If the proposed name would not be a suitable resource identifier, the resource is not renamed and a message is returned indicating that the resource was not renamed, at 330; otherwise the resource is renamed and a message is returned indicating that the resource was renamed, at 335.

If, at 320, the resource could have custom properties, the repository framework determines, at 340, whether the resource is a collection or a link. If the resource is a collection or a link, the displayname property is set as the proposed name, a message is returned that the resource was renamed, and the resource identifier is renamed to resemble the displayname, at 345.

If a resource is not a collection or a link, the repository framework determines, at 350, whether the proposed name would modify an extension (if an extension exists) and the extension should be preserved. An extension should be preserved, for example, if an operating system relies on extensions to determine the content of the resource. If the extension would not be modified or the extension need not be preserved, at 345 the displayname corresponding to the resource is renamed to the proposed name, a message is returned indicating that the resource was renamed, and the corresponding resource identifier is renamed such that it reflects the proposed name. Otherwise, at 355, the extension is added to a proposed resource identifier, which resembles the proposed name. After the extension is added, the proposed resource identifier is set as the resource identifier (i.e. the resource identifier is renamed), the displayname is set as the proposed name, and a message is sent to a user indicating that the resource was renamed, at 345.

In alternative implementations, instead of a displayname being a custom property, a displayname may be a default property and the processes of FIG. 3 may differ to reflect that difference. For example, 320 may include determining whether the resource can have a displayname property, regardless of whether it is custom or not.

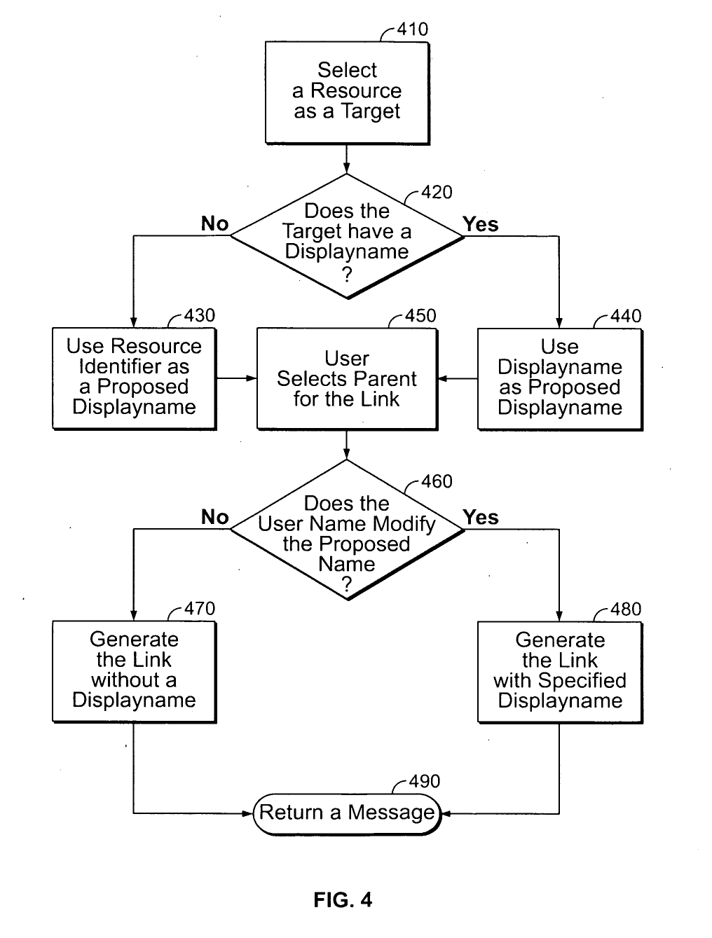

FIG. 4 is a flowchart illustrating generation of links. In relation to FIG. 4, parent is the file folder where a link is expected to be generated. A repository framework, such as the repository framework 110, performs several of the processes of FIG. 4. In alternative implementations the processes may be performed by an adapter that is part of the repository framework. At 410 a resource is selected for the generation of a link. The resource that is selected is a “target resource” (i.e. the resource to which a link will refer). This selection process may take place in a user interface and the selection may be forwarded to the repository framework.

The repository framework determines whether the target resource has a displayname at 420. Any technique may be used to make this determination. For example, depending on the implementation of the repository framework and/or the repository in which the target resource resides, this can involve checking the properties of the target resource to see if a displayname property is null. The displayname property may be null, for example, if the displayname was never set or if a displayname was deleted.

If the target resource does not have a displayname, the resource identifier of the target resource is used as a proposed displayname for the link at 430. Otherwise, the displayname of the target resource is the proposed displayname for the link. This proposed displayname is then presented to a user, for example, through a user interface, and the user has an opportunity to modify the proposed displayname. In addition, the user can specify the parent for the link (i.e. where the link should be generated). At 450, the repository framework determines if the proposed displayname was modified. The repository framework may perform this task by comparing the proposed displayname with user input. If the proposed displayname of the link was modified, the link is generated with the modified displayname at 470; otherwise, the link is generated without a displayname at 480. In either case a message is returned indicating that the link was generated, at 490. If the link is generated without a displayname, the repository framework may later identify the link by the resource identifier instead of a displayname.

Although FIGS. 2, 3, and 4 illustrate displayname synchronization in specific situations (e.g. generation of a link), the techniques may apply to other synchronization scenarios that may involve the synchronization of other types of resources or other events that result in the modification of a displayname (e.g. generating resources, copying resources, moving resources, etc.). Also, although FIGS. 2, 3, and 4 describe several processes as being performed by the repository framework, other software components may perform these processes.

Also, although FIGS. 2, 3, and 4 are composed of a certain number of processes, additional and/or different processes can be used instead. Similarly, the processes need not be performed in the order depicted. For example, an implementation that includes the technique illustrated in FIG. 4 need not include the processes related to 450, for example, if the parent is selected as part of a process that receives a user decision to generate the link (not shown).

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., tangible media such as magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Although only a few implementations have been described in detail above, other modifications are possible. For example, in alternative implementations of FIGS. 2, 3, and 4, the messages may be returned to an application, instead of a user, or messages need not be returned at all. In alternative implementations of FIG. 4, this may involve generating a link but not sending a message. Other implementations may be within the scope of the following claims.

1. A computer-implemented method comprising:
providing a parent, a proposed name, custom properties, and a flag value for a resource to a repository framework;
determining, by the repository framework, whether the parent forbids custom properties and whether the flag is true;
if the parent forbids custom properties and the flag is true, determining whether the proposed name is a suitable resource identifier;
if the proposed name is not a suitable resource identifier, returning a message to a user that the resource cannot be generated;
if the parent does not forbid custom properties and/or the flag is true, or if the proposed name is a suitable resource identifier, determining whether the parent forbids customs properties and whether there are custom properties;
if the parent forbids customs properties and there are custom properties, returning a message to a user that the resource cannot be generated;
if the parent does not forbid customs properties and that there are custom properties, determining whether there are custom properties that should be set for the resource; and
if it is determined that there are custom properties that should be set for the resource;
creating the resource with a valid resource identifier and a displayname as a property and returning a message indicating that the resource was generated; or
if it is determined that there are no custom properties that should be set for the resource; creating the resource with a valid resource identifier and returning a message indicating that the resource was generated.

2. A method as in claim 1, wherein the parent is a file folder where the resource is expected to be generated.

3. A method as in claim 1, wherein the flag is a value that represents whether a content-type extension of a file should be preserved.

4. A method as in claim 1, wherein the repository framework is coupled to a plurality of data repositories.

5. A method as in claim 4, wherein adapters couple the repository framework to the plurality of data repositories.

6. A method as in claim 4, wherein at least a portion of the data repositories use different naming conventions.

7. A method as in claim 1, further comprising: visually displaying a message to a user indicating whether the message can be generated.

8. A computer-implemented method comprising:
providing a resource, a proposed name for the resource, a flag value to a repository framework;
determining if the proposed name differs from a current name for the resource, the current name being a displayname or a resource identifier of the resource;
if the proposed name does not differ from the current name for the resource, sending a message to a user indicating that the resource was not renamed;
if the proposed name differs from the current name for the resource, determining whether the resource can have custom properties;
if the resource can have custom properties, determining whether the resource is a collection or a link;
if the resource cannot have custom properties, determining whether the proposed name comprises a suitable resource identifier;
if the proposed name comprises a suitable resource identifier, renaming the resource based on the suitable resource identifier and sending a message to a user indicating that the resource was renamed;
if the proposed name does not comprise a suitable resource identifier, sending a message to a user indicating that the resource was not renamed;
if the resource is a collection or a link, setting the displayname as the proposed name, sending a message to a user that the resource was renamed, and renaming the resource identifier to resemble the displayname;
if the resource is not a collection or a link, determining whether the proposed names modifies an extension, if any, and whether the extension, if any, should be preserved; and
if the proposed names modifies an extension and the extension should be preserved, adding an extension to the proposed name, setting the proposed resource identifier as the resource identifier, setting the displayname as the proposed name, and sending a message to a user indicating that the resource was renamed; or
if the proposed names does not modify an extension and/or the extension should not be preserved, renaming the displayname to the proposed name, sending a message to a user indicating that the resource was renamed, and renaming the resource identifier such that it resembles the proposed name.

9. A method as in claim 8, wherein the parent is a file folder where the resource is expected to be generated.

10. A method as in claim 8, wherein the flag is a value that represents whether a content-type extension of a file should be preserved.

11. A method as in claim 8, wherein the repository framework is coupled to a plurality of data repositories.

12. A method as in claim 11, wherein adapters couple the repository framework to the plurality of data repositories.

13. A method as in claim 11, wherein at least a portion of the data repositories use different naming conventions.

14. A method as in claim 8, further comprising: visually displaying a message to a user indicating whether the message can be generated.

15. An article comprising a tangible, machine-readable medium storing instructions operable to cause one or more machines to perform operations comprising:
providing a parent, a proposed name, custom properties, and a flag value for a resource to a repository framework;
determining, by the repository framework, whether the parent forbids custom properties and whether the flag is true;
if the parent forbids custom properties and the flag is true, determining whether the proposed name is a suitable resource identifier;
if the proposed name is not a suitable resource identifier, returning a message to a user that the resource cannot be generated;
if the parent does not forbid custom properties and/or the flag is true, or if the proposed name is a suitable resource identifier, determining whether the parent forbids customs properties and whether there are custom properties;
if the parent forbids customs properties and there are custom properties, returning a message to a user that the resource cannot be generated;
if the parent does not forbid customs properties and that there are custom properties, determining whether there are custom properties that should be set for the resource; and
if it is determined that there are custom properties that should be set for the resource;
creating the resource with a valid resource identifier and a displayname as a property and returning a message indicating that the resource was generated; or
if it is determined that there are no custom properties that should be set for the resource; creating the resource with a valid resource identifier and returning a message indicating that the resource was generated.

16. An article as in claim 15, wherein the parent is a file folder where the resource is expected to be generated.

17. An article as in claim 15, wherein the flag is a value that represents whether a content-type extension of a file should be preserved.

18. An article as in claim 15, wherein the repository framework is coupled to a plurality of data repositories.

19. An article as in claim 18, wherein adapters couple the repository framework to the plurality of data repositories.

20. An article as in claim 18, wherein at least a portion of the data repositories use different naming conventions.
